(19) United States
(12) Patent Application Publication
(10) Pub. No.: US 2012/0209688 A1
(43) Pub. Date: Aug. 16, 2012

(54) SYSTEMS AND METHODS FOR MULTI-PLATFORM TRANSACTION CARD ACCESS AND MANAGEMENT

(76) Inventors: Michelle Lamothe, Maple Grove, MN (US); John Tomczyk, Shoreview, MN (US); Martha E. Weaver, River Falls, WI (US)

(21) Appl. No.: 13/396,939

(22) Filed: Feb. 15, 2012

Related U.S. Application Data
(63) Continuation of application No. 61/443,082, filed on Feb. 15, 2011.

(51) Int. Cl. G06Q 90/00; G06Q 30/02

(52) U.S. Cl. 705/14.27; 235/380

(57) ABSTRACT

Embodiments relate to transaction cards and other carriers and more particularly to systems and methods for creating multi-platform transaction cards and carriers and managing information and access related to those items. Such a carrier provides a recipient or user with a variety of options for redeeming the carrier and, when a QR code is used, additionally provides access to digital account access and information and other features. On the merchant's or other entity's side, use of the QR code by the recipient or user provides opportunities for the entity to obtain additional information about the user and their use of the card, including recipient transaction histories, brand-specific marketing opportunities and other merchant-side benefits. Embodiments thereby provide a multitude of user- and entity-side benefits to the use and management of carriers and related information.

### RELATED APPLICATION

This application claims priority to U.S. Provisional Patent Application No. 61/443,082 entitled SYSTEMS AND METHODS FOR MULTI-PLATFORM TRANSACTION CARD ACCESS AND MANAGEMENT, filed Feb. 15, 2011, which is incorporated herein by reference in its entirety.

### TECHNICAL FIELD

The invention relates generally to transaction cards and other carriers and more particularly to systems and methods for creating multi-platform transaction cards and carriers and managing information and access related to those items.

### BACKGROUND

Transaction cards, such as gift cards, stored value cards, loyalty cards, membership cards, rewards cards, identification cards, coupons and other promotional carriers and items are often presented in hardcopy form, such as a plastic card or key fob which can be purchased at a brick-and-mortar store, or obtained in virtual form, such as a transaction card purchased online and delivered via email. Both forms of transaction cards can typically be used or redeemed in a variety of ways. For example, a plastic transaction card can be presented at a brick-and-mortar store to be redeemed by scanning a bar code or swiping a magnetic stripe on the card in order to access the card's account and value. Many plastic transaction cards can also be redeemed online by manually entering, by the recipient of the card, an account number and personal identification number (PIN) printed on the card at the time of use. Virtual transaction cards can be redeemed in similar ways, such as by printing a hardcopy of the virtual transaction card or related email in order to present it at a brick-and-mortar store, or by entering the virtual transaction card information online, such as by manually typing in the account information or clicking through the virtual transaction card in order to create an online account. Likewise, loyalty, membership or rewards cards can be utilized in person, such as by a retailer entering information obtained from the card into a transaction system, or virtually, such as when the holder of the card enters data obtained from the card into a computer, smart phone, tablet computer or other device to obtain rewards points, recognition, or other benefits.

There are several drawbacks associated with both manual and virtual transaction cards, both from the recipient's standpoint as well as the merchant's. For both hardcopy and virtual forms, managing the cards by the recipients can be inconvenient. Multiple plastic transaction cards take up space in a wallet or purse, and printed virtual transaction cards create papers that must be carried and presented in hardcopy form. Further, managing accounts can be cumbersome or difficult. If a recipient has multiple cards for the same merchant, in either form, they often cannot be combined into a single card, making the tracking of values and balances challenging, not to mention storage and tracking of the physical cards themselves cumbersome. From a merchant's perspective, it is difficult or impossible to obtain information about the purchaser or recipient of transaction cards in order to improve products and services, provide marketing materials and information, and manage customer and usage information. This difficulty comes into play, for example, when consumers pay cash for gift cards and subsequently gift the cards to recipients unrelated to the initial transaction.

Relatedly, new opportunities are presented by the prevalence of smart phones, tablet computers and other digital devices that make mobile computing and information management more convenient. Many merchants and services already offer digital coupons and offers that can be redeemed by presenting the coupon or offer to a merchant on a smart phone. Additionally, new technologies and features are also being developed for smart phones and similar devices to make using the devices to access information even more convenient. So-called QR codes and other two-dimensional bar codes enable a user to simply take a picture of the code in order to access a URL encoded in the QR code.

Nevertheless, these digital systems are still evolving and also provide disadvantages. For example, entering a website address, or URL, on a smart phone can be time-consuming and cumbersome given the often abbreviated keyboards and smaller screens. Additionally, current uses of QR codes are typically limited to accessing static information presented by a merchant or other organization.

Therefore, there is a need for improved systems and methods for managing transaction cards and their related information utilizing new digital technologies.

### SUMMARY

Embodiments relate to transaction cards and other carriers and more particularly to systems and methods for creating multi-platform transaction cards and carriers and managing information and access related to those transaction cards or carriers. In one embodiment, a hardcopy transaction card or other physical carrier can comprise printed account information, such as an account number and PIN, as well as that same information encoded on a magnetic stripe and in a two-dimensional bar code, such as a QR code. Such a transaction card or carrier provides a recipient with a variety of options for redeeming the card and, when the QR code is used, additionally provides access to digital account access and information and other features. On the merchant's side, or the side of some other entity associated with the card or carrier, use of the QR code by the recipient provides opportunities for the merchant or entity to obtain additional information about the recipient and their use of the card or carrier, including recipient transaction histories, brand-specific marketing opportunities and other merchant-side benefits. Embodiments thereby provide a multitude of recipient- and merchant-side benefits to the use and management of transaction cards and related information.

Additionally, embodiments have applicability to embodiments other than transaction cards or carriers, though the general term “carrier” will be used herein throughout for convenience to refer to gift, stored value, loyalty, membership, identification, informational and other cards, key fobs and related items. For example, loyalty, membership or reward programs can utilize systems and methods disclosed herein, thereby allowing merchants to understand the buying habits of consumers and offer incentives to encourage similar or other desired behaviors. Systems and methods can also be used to track rewards that can later to used to purchase additional goods and/or services from the merchant or from a merchant or other entity network or rewards program. Embodiments can also be used to manage charitable contributions, for example parent-teacher associations (PTA) may partner with a network of local retailers who donate a portion of member purchases to the PTA as a fundraiser, or members of organizations can track their annual giving for year-end tax reporting, or individuals or families can use a health card that carries information regarding prescriptions, medical diagnoses, insurance coverage and the like. Thus, the general term “entity” will be used herein throughout for convenience to refer to these and other organizations as well as merchants and other entities. Fundamentally, while transaction card embodiments are described and discussed herein, these embodiments are only examples and are not limiting with respect to the broader applicability of the invention.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a depiction of a transaction card according to an embodiment.

FIG. 2A is a depiction of a smart phone and a transaction card according to an embodiment.

FIG. 2B is a depiction of a graphical user interface of the smart phone of FIG. 2A.

FIG. 2C is a depiction of a graphical user interface of the smart phone of FIG. 2A.

FIG. 3 is a flowchart of a method according to an embodiment.

FIG. 4 is a block diagram of a printing system according to an embodiment.

FIG. 5 is a flowchart of a method according to an embodiment.

While the invention is amenable to various modifications and alternative forms, specifics thereof have been shown by way of example in the drawings and will be described in detail. It should be understood, however, that the intention is not to limit the invention to the particular embodiments described but rather to include all modifications, equivalents, and alternatives.

### DETAILED DESCRIPTION

Embodiments relate to transaction cards or other carriers and more particularly to systems and methods for creating multi-platform transaction cards and managing information and access related to those transaction cards. In one embodiment, a hardcopy transaction card or carrier can comprise printed account information, such as an account number and PIN, as well as that same information encoded on a magnetic stripe and in a two-dimensional bar code, such as a QR code. Such a transaction card or carrier provides a recipient with a variety of options for redeeming the card and, when the QR code is used, additionally provides access to digital account access and information and other features. On the merchant's or other entity's side, use of the QR code by the recipient provides opportunities for the merchant or entity to obtain additional information about the recipient and their use of the card or carrier, including recipient transaction histories, brand-specific marketing opportunities and other merchant-side benefits. Embodiments thereby provide a multitude of recipient- and merchant-side benefits to the use and management of transaction cards and related information.

Additionally, embodiments have applicability to embodiments other than transaction cards, such as benefit or assistance cards, for example health care and insurance, social security and food stamps; financial information, such as taxes, savings plans, retirement accounts, banking, trading accounts and others; registration, licensing or membership information, including health club membership, professional organization membership, loyalty program membership and government-issued and other licenses; ticketing, such as for concerts and events, sporting venues, theme parks and the like; business cards and other professional contact information; and many other applications. Further, the medium can be something other than a card, such as a label, advertisement, envelope, flyer, circular, magazine, newspaper, letter, billboard, paper, document, package, box, hardcopy or digital email, web page, media screen such as computer, TV or other digital device screen, CD, book, hang tag, sign, ticket, cup or mug, bottle, container, case, poster, bag, sticker, coupon, wrapper or virtually any other item which can be printed or carry a printed item or message. Therefore, while transaction card embodiments are described and discussed herein, these embodiments are but examples and are not limiting with respect to the broader applicability of the invention. For convenience, the term “carrier” will be used herein throughout to refer generally to various embodiments of these items.

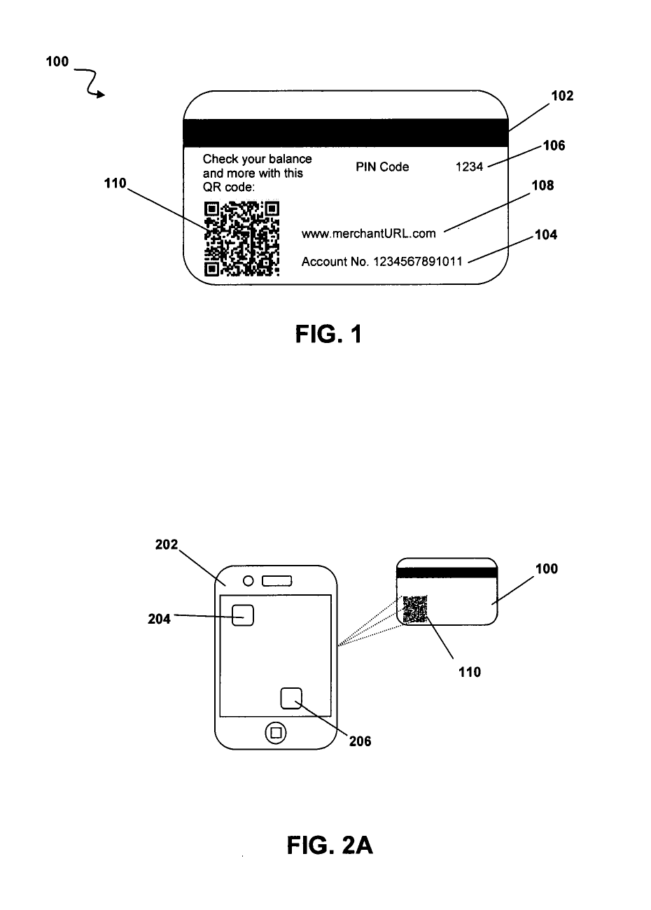

An embodiment of a carrier 100 is depicted in FIG. 1. Carrier 100 can be provided in a hardcopy form, comprising plastic, paper, a composite material, or some other suitable material in embodiments, or carrier 100 can be provided in virtual form, such as via email, SMS, MMS, a mobile application, a social networking message or other Internet site communication, or in some other virtual form. It can be appreciated by those skilled in the art that virtual forms of carrier 100 can vary from the depiction in FIG. 1. For example, a virtual depiction of carrier 100 can include a depiction of a magnetic stripe 102 because recipients are familiar with such a depiction of a carrier, even though a virtual magnetic stripe 102 is non-functional, or such a depiction can be omitted.

Carrier 100 also comprises account information in an embodiment, including an account number 104 and personal identification number (PIN) code 106. Account number 104 and PIN code 106 are encoded on magnetic stripe 102 in hardcopy embodiments such that a recipient of carrier 100 can use or redeem carrier 100 in a brick-and-mortar store by swiping the card in a magnetic card reader. In other embodiments, carrier 100 comprises a machine-readable conventional barcode or chip (not depicted,) instead of or in addition to magnetic stripe 102. A chip can be suitable for use in a chip-and-PIN system, which is more commonly used in Europe and other regions. A URL 108 associated with the merchant or issuer (generally “entity”) of carrier 100 is also included in embodiments, such that a recipient can access online account information related to carrier 100 by entering account number 104 and PIN code 106 in an entity's web site or visit the issuing entity's web site for some other reason.

In an embodiment, carrier 100 also comprises a bar code and/or two-dimensional bar code, such as a QR code 110 as depicted in FIG. 1. In other embodiments, carrier 100 comprises a JagTag, ScanLife code, Microsoft tag or some other suitable two-dimensional or other machine-readable code. QR code 110 enables a recipient to access additional information related to carrier 100, including account and balance information, transaction history, merchant information, transaction card value reloading information, marketing and other messaging from the issuing entity, instant promotions and coupons, card consolidation and balance transfer information, card conversion (such as from hardcopy to virtual), e-wallet transfer information, virtual marketplace information, rewards and loyalty information and more. In other embodiments, accessing QR code 110 provides the recipient with a list of entity locations. In GPS-enabled phones and devices, the list can be presented in order of those physically closest to the recipient, where the user can be automatically located via the GPS system. In other embodiments, a user can enter a ZIP code or other location information manually. Additional information, such as store hours, contact information, services offered, and the like, can also be provided. In another embodiment, QR code 110 can access an online scheduling application enabling the recipient to schedule an appointment with the entity or at an entity location. By accessing the scheduling application through QR code 110, recipient information can be auto-filled, appointments can be scheduled based on past appointments and timing, and other information can be more easily and conveniently provided. With respect to certain applications, such as gym memberships reimbursed as part of health insurance plans, compliance and usage can also be tracked on the entity side.

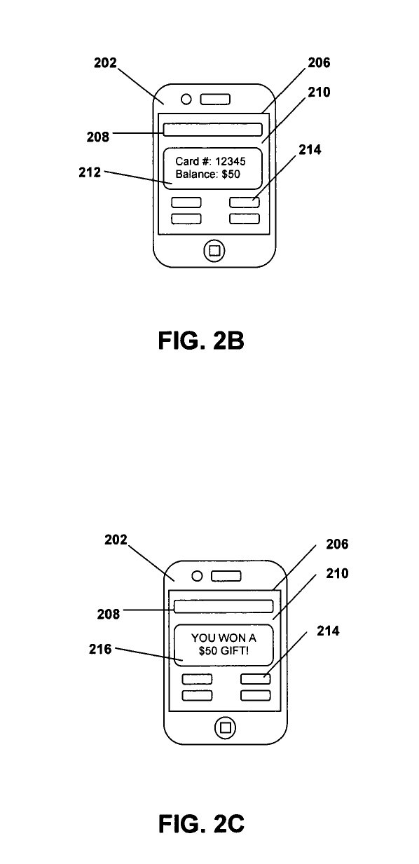

In an embodiment, and referring to FIG. 2A, a recipient or other user accesses this information by taking a picture of or otherwise scanning QR code 110 with a camera (not visible in FIG. 2A) or other suitable device, such as with a mobile phone 202 or tablet computer camera. In an embodiment, a smart phone application, or “app” 204, is used to take the picture or otherwise digitally read QR code 110. App 204 then directs a web browser 206 to a URL encoded in QR code 110.

Referring to FIG. 2B, the URL is a personal URL (PURL) 208 in an embodiment that, in browser 206, opens a personal account page 210. Personal account page 210 can take many forms according to a purpose or function of carrier 100. For example, as depicted in FIG. 2B personal account page 210 includes balance information 212 related to carrier 100 or an account associated therewith. Page 210 also provides a series of buttons 214 that enable a user to interact with the account or site to, for example, top up a balance, make a purchase or transaction using the card, edit account information, request further information or assistance, and link multiple carriers to a single account, among others. With respect to the linking of multiple carriers to a single account, for example, a user can have both a loyalty card and a gift card with a single entity, or may have multiple gift cards associated with a single entity. Linking or associating a multiple carriers with a single user account links those carriers on the entity side, such that, for example, an entity database of user accounts associates the multiple carriers with the same account. Other entity side linkings or associations are also possible, as appreciated by those skilled in the art. On the user side, those carriers or virtual representations thereof can be linked on page 210 such that they can be more easily managed alone or in concert, and/or the carriers can be linked in a virtual wallet of carriers. Before accessing personal account page 210, a user can be directed to a PIN entry screen in order to enter PIN 106 or some other password or identifier before being permitted to access to certain information.

Referring to FIG. 2C, in another embodiment the URL encoded in QR code 110 can be associated with a promotional contest, such as an instant win feature. Upon a user scanning QR code 110 from carrier 100 or some other item, such as a flyer or promotional package, the user can be directed to an instant win screen 216 if the account number associated with that particular carrier 100 or item was selected to be a winner. The particulars of the winner selection process can vary in embodiments. For example, a set number of carriers within an overall batch can be randomly selected to win, or every carrier can be associated with some sort of prize, or some other arrangement as appreciated by those skilled in the art.

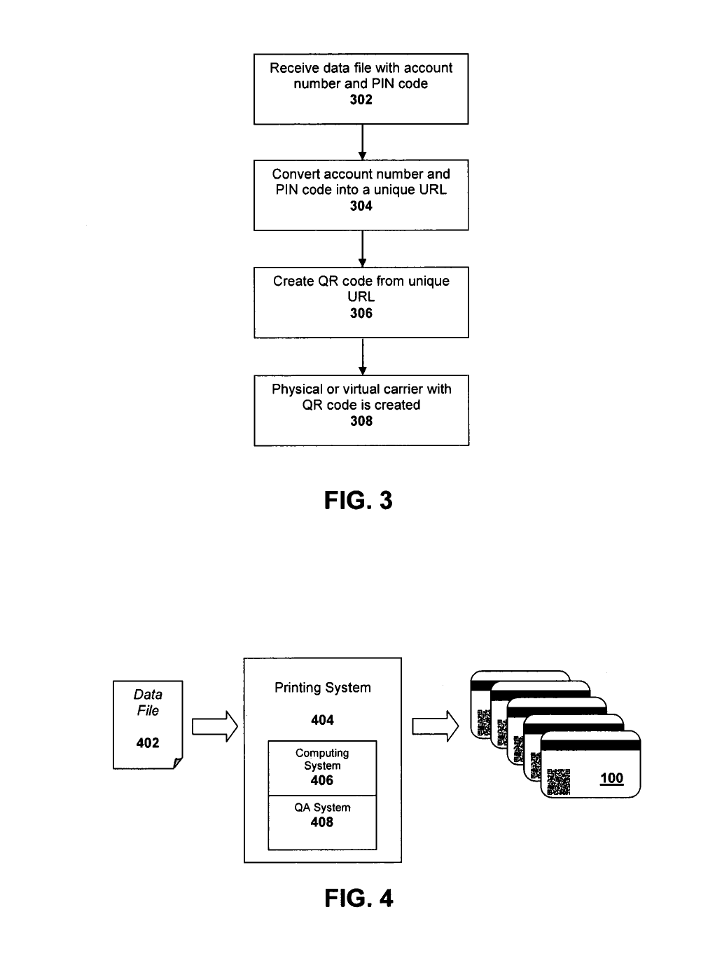

Returning to QR code 110 and the related URL, in an embodiment QR code 110 is encoded with a URL that is unique. In other words, generally, no two carriers 100 associated with the same entity comprise the same URL encoded in QR code 110. In an embodiment, the URL is unique in that it is created from account number 104 and PIN code 106 by a computer system. Referring to FIGS. 3 and 4, a data file 402 including account number 104 and PIN code 106 is received by a printing system 404 at 302. Data file 402 can comprise a spreadsheet, comma separated value (CSV) document, text document or other document for organizing information and can be communicated to printing system 404 by email, FTP, server transaction, upload from disk or drive, or some other suitable fashion. In embodiments, data file 402 is created by an entity or intermediary organization for a batch of carrier 100 and then provided, at 302, to a printing organization and/or system for creation of carrier 100 that follow their account numbering conventions and include authenticating information such that when a recipient attempts to redeem a carrier 100, the carrier 100 is recognized by the entity's system, absent any intermediary tampering, fraud or counterfeiting.

As understood by one of skill in the art, printing system 404 can comprise computers, servers, databases, memory, internet connectivity and other features enabling receipt, manipulation, storage and other handling of data file 402 as part of data management and printing processes, depicted generally as computing system 406. In embodiments, computing system 406 can be integrated with and/or distinct from but in communication with printing system 404. For example, printing system 404 can be connected to an internal company network, intranet, or the internet, such that physically external computing devices form a part of the system 404.

At 304, account number 104 and PIN code 106 are converted into a unique URL. In one embodiment, the URL comprises a variable-length URL in order to improve security. In embodiments, this conversion is carried out internal or external to printing system 404. For example, an organization intermediate a merchant and a printing company can manage the data and provide the necessary information to printing system 404. In other embodiments, the intermediary organization provides software, algorithms and/or other information to printing system 404 such that system 404 can run the software, algorithms and/or other information to create unique URLs or PURLs, and therefore QR codes 110, according to their methodologies. In embodiments, information regarding the unique URL or PURL can be communicated back to the intermediary organization and/or merchant in order to verify the information, update the merchant's records, and the like.

At 306, a QR code is generated from the unique URL or PURL. As stated above, this can be carried out by printing system 404, by an intermediary organization, and/or by the two in cooperation. In some embodiments, QR code 110 is encrypted for enhanced security. In other embodiments, for example those in which QR code 110 is not used to access account or other secure information but rather only advertising or marketing information, QR code 110 can be left unencrypted. Other security measures can also be provided and implemented, such as secure servers, communications, connections and access, between any or all of printing system 404, intermediary organization(s) and/or merchants. At 308, an item, such as carrier 100, is printed or otherwise created to include the account number, PIN code and QR code.

In one printed embodiment, carrier 100 is printed using drop-on-demand (DoD), inkjet, methyl ethyl ketone (MEK), thermal imaging, die sublimation, a toner-based device or some other suitable printing methodology, such as lithographic or web printing, using a CPST, AZ, Matica, 509 technology, Datacard and/or some other suitable imaging line as part of printing system 404. Given the wide applicability to cards and other items as discussed herein above, a range of printing methodologies, technologies and systems can be used, mainly driven in embodiments by the particular item(s) to be produced, as appreciated by those skilled in the art.

Printed carrier 100, specifically QR code 110, is then verified by a quality assurance (QA) system 408. In one embodiment, each printed carrier 100 is read by a camera or other optical system to convert QR code 110 back into a data string in order to verify that the string as printed matches the unique URL generated from the data file. The camera of QA system 408 can be in-line with a printing process in embodiments and can also grade the decodability of QR code 110 to ensure the printed code meets applicable printing standards. If these standards are not met and/or the printed data string in the QR code does not match that of the data file or is duplicative, the carrier 100 is then rejected and, if applicable, reprinted.

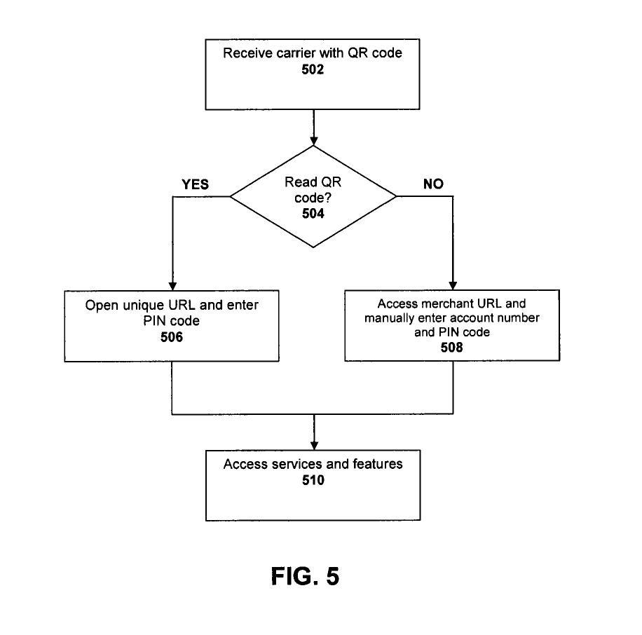

The item, such as carrier 100 whether hardcopy or virtual, is then purchased, transactioned or otherwise obtained by a recipient. Referring to FIG. 5, the carrier with QR code 110 is received by a recipient or user at 502. At 504, the user can access additional information by either reading QR code automatically, such as with mobile app 204 and camera on smart phone 202 which then opens the unique URL encoded in QR code 110 at 506, or manually, such as by entering merchant URL 108 and manually entering account number 104 and PIN code 106 at 508. In embodiments in which mobile app 204 is used, app 204 can be brand-specific to the merchant related to transaction card 100 or can be a general QR code app, such as SCANLIFE or some other similar app.

At 510, card services and features can then be accessed. In embodiments, these services and features are managed and presented directly by the entity or other organization, the term entity used herein throughout to refer generally to a provider of products, services, information or some other benefit to a recipient or user. In other embodiments, an intermediary organization manages and implements these services and features for an entity or group of entities. Therefore, when the features are accessed at 510, a user can be accessing, via the internet, an entity's computer system or an intermediary's computer system, depending upon the arrangement.

In one embodiment, the user is first required to register transaction card 100 and/or create an account, thus enabling the entity to capture information about the user and use of transaction card 100 and store that information in a database. In embodiments in which an intermediary is involved, the information can be captured, tracked and/or analyzed by the intermediary and subsequently reported upon to the entity. In one embodiment, a user can be offered points, monetary credit or some other incentive in order to complete some or all of the registration process. Additionally, the optional use of an entity-specific app and entity-branded site accessed via the URL provides the entity with branding and other promotional opportunities. Other benefits provided to the entity include the ability to repurchase cards at a discount; issue promotions and coupons; issued time-based promotions, coupons and marketing information; issue loyalty program, gaming, toys, icons or other points; provide member-only information such as exclusive recipes, music, pictures, wallpapers, ringtones and other items; provide marketing messages; and issue information messages, such as advising of recipients of weather-related outages or closures and other non-scheduled service-related events or incidents.

Embodiments can also utilize features as discussed and disclosed in co-pending U.S. patent application Ser. Nos. 11/242,603, entitled SYSTEM AND METHOD FOR ELECTRONICALLY MANAGING INDIVIDUAL AND BUSINESS INFORMATION, and filed on Oct. 3, 2005, and 13/216,814, entitled DYNAMIC ELECTRONIC COMMUNICATION DEVICE, and filed on Aug. 24, 2011, which are hereby incorporated by reference in their entireties.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, locations, configurations etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention can comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A system comprising:
a carrier associated with an entity and comprising a machine-readable code encoded with a uniform resource locator (URL) unique to the carrier;
a web site associated with the entity and accessible at the URL; and
a user device configured to scan the machine-readable code to access the web site on the device absent user entry of the unique URL and to do at least one of accept entry of information to associate the carrier with a user account, present information related to a user account or accept entry of information related to a user account, via the web site.

2. The system of claim 1, wherein the device is configured to automatically open a browser program of the device to access the web site upon scanning of the machine-readable code.

3. The system of claim 1, wherein the device is configured to automatically open an application program on the device upon scanning of the machine-readable code.

4. The system of claim 3, wherein the application program is associated with the entity.

5. The system of claim 1, wherein the device is configured to store a virtual representation of the carrier associated with the entity and a user account.

6. The system of claim 5, wherein the device is configured to store a plurality of representations of virtual carriers, each virtual carrier associated with an entity and a user account.

7. The system of claim 1, wherein the user account comprises a loyalty program account associated with the entity.

8. The system of claim 7, wherein the web site is configured to present a loyalty program account balance.

9. The system of claim 1, wherein the web site is configured to present an instant win contest result.

10. The system of claim 9, wherein the user account is a new user account and the web site is configured to accept user information.

11. The system of claim 1, wherein the user account comprises a gift card account associated with at least one entity.

12. The system of claim 11, wherein the web site is configured to present a gift card balance.

13. The system of claim 1, wherein the carrier further comprises a personal identification number (PIN) for entry prior to the at least one of associate the carrier with a user account, present information related to a user account or accept information related to a user account via the web site.

14. The system of claim 1, wherein the carrier further comprises at least one of a magnetic stripe or an embedded microchip.

15. The system of claim 1, wherein the carrier comprises at least one of a card, a stamp, a ticket, a license, a bracelet, a fob, a paper, a label, an advertisement, an envelope, a flyer, a circular, a magazine, a newspaper, a letter, a billboard, a document, a package, a box, a hardcopy or digital email, an SMS, an MMS, a digital message, a digital post, a digital application, a web page, a media screen, a compact disc, a book, a hang tag, a sign, a writing implement, a stylus, a cup or mug, a bottle, a container, a case, a poster, a bag, a garment, a sticker, a coupon, a wrapper or a receipt.

16. The system of claim 1, wherein the machine-readable code comprises at least one of a bar code, a two-dimensional bar code, a QR code, a JagTag, a ScanLife code or a tag.

17. The system of claim 1, wherein the web site is configured to do at least one of present or accept user location information.

18. The system of claim 1, wherein the web site is configured to link a plurality of carriers with a single user account.

19. The system of claim 18, wherein the plurality of carriers are associated with the same entity.

20. The system of claim 1, wherein the user account is associated with a particular user.

21. The system of claim 1, wherein the carrier comprises a physical carrier.

22. The system of claim 1, wherein the user device is configured to accept information related to managing a user account.

23. A loyalty program associated with a entity comprising:
a loyalty program carrier presenting merchant information and comprising a personal identification number (PIN) and a machine-readable code encoded with a uniform resource locator (URL) unique to the carrier;
an internet site associated with the entity at the URL configured to present entity information upon machine reading of the code by a user device and to present user loyalty program account information comprising at least an account balance upon entry via the user device of the PIN; and
a database configured to store data associated with user interaction with the entity collected using the loyalty program carrier.

24. The program of claim 23, wherein the carrier further comprises at least one of an entity URL, a magnetic strip, a machine-readable microchip, a loyalty program account number or a user name.

25. The program of claim 23, wherein the carrier comprises at least one of a card, a stamp, a ticket, a license, a bracelet, a fob, a paper, a label, an advertisement, an envelope, a flyer, a circular, a magazine, a newspaper, a letter, a billboard, a document, a package, a box, a hardcopy or digital email, an SMS, an MMS, a digital message, a digital post, a digital application, a web page, a media screen, a compact disc, a book, a hang tag, a sign, a writing implement, a stylus, a cup or mug, a bottle, a container, a case, a poster, a bag, a garment, a sticker, a coupon, a wrapper or a receipt.

26. The program of claim 23, wherein the carrier comprises a physical carrier.

27. The program of claim 23, further comprising the user device configured to machine-read the code, accept entry of the PIN and present the internet site.

28. The program of claim 27, wherein the device is configured to present the internet site via a browser.

29. The program of claim 27, wherein the device is configured to present the internet site via an application.

30. The program of claim 27, wherein the device is configured to store a virtual version of the carrier.

31. A gift card program associated with at least one entity comprising:
a gift card program carrier presenting information related to the at least one entity and comprising a personal identification number (PIN) and a machine-readable code encoded with a uniform resource locator (URL) unique to the carrier;
an internet site associated with the entity at the URL configured to present information related to the at least one entity upon machine reading of the code by a user device and to present user gift card program account information comprising at least a gift card balance upon entry of the PIN via the user device; and
a database configured to store data associated with user interaction with the at least one merchant based on use of the gift card program carrier.

32. The program of claim 31, wherein the carrier further comprises at least one of an entity URL, a magnetic strip, a machine-readable microchip, a loyalty program account number or a user name.

33. The program of claim 31, wherein the carrier comprises at least one of a card, a stamp, a ticket, a license, a bracelet, a fob, a paper, a label, an advertisement, an envelope, a flyer, a circular, a magazine, a newspaper, a letter, a billboard, a document, a package, a box, a hardcopy or digital email, an SMS, an MMS, a digital message, a digital post, a digital application, a web page, a media screen, a compact disc, a book, a hang tag, a sign, a writing implement, a stylus, a cup or mug, a bottle, a container, a case, a poster, a bag, a garment, a sticker, a coupon, a wrapper or a receipt.

34. The program of claim 31, further comprising the user device configured to machine-read the code and present the internet site.

35. The program of claim 34, wherein the device is configured to present the internet site via a browser.

36. The program of claim 34, wherein the device is configured to present the internet site via an application.

37. The program of claim 34, wherein the device is configured to store a virtual version of the carrier.

38. The program of claim 31, wherein the internet site is configured to present a user gift card balance conversion option.

39. The program of claim 38, wherein the user gift card balance conversion option comprises at least one of combining balances or increasing a balance.

40. The program of claim 31, wherein the carrier comprises a physical carrier.
